(19) United States
(12) Patent Application Publication
(10) Pub. No.: US 2005/0105141 A1
(43) Pub. Date: May 19, 2005

(54) Scanning device have adjustable image amplification of lens

(76) Inventor: Chih-Chieh Wu, Ping-Tung (TW)

Correspondence Address: BIRCH STEWART KOLASCH & BIRCH, PO BOX 747, FALLS CHURCH, VA, 22040-0747, US

(21) Appl. No.: 10/713,042

(22) Filed: Nov. 17, 2003

(51) Int. Cl. H04N 1/04

(52) U.S. Cl. 358/474

(57) ABSTRACT

The present invention provides a device and a method to adjust the image, which is focused on the photosensor. The device comprises a lens and a photosensor, which are moved out of the chassis to place on the housing of the scanning device, such that the volume of chassis can be reduced. In addition, the mirror, lens and photosensor would be adjusting the angle that followed the shift position of the chassis, such that the image can be focused on the photosensor.

### BACKGROUND OF THE INVENTION

1. Field of the Invention

The present invention generally relates to a scanning device, and more particularly to a scanning device have an adjustable the image amplification of lens to obtain the correct image data.

2. Description of the Prior Art

Flatbed scanning device are widely used with computer systems for converting printed data into image signals. An optical scanning module is the most important component of the flatbed-scanning device. The optical scanning module commonly comprises a housing with an opening for receiving the imaged light that transmitted from a document sheet, an optical sensor (or photosensor) installed inside the housing for converting the image light into corresponding image signals, and a plurality of lenses for focusing the image light onto the optical sensor.

The optical scanning module has a fixed resolution that determined by the image amplification of the optical scanning module and the resolving power of the optical sensor. The image amplification of the optical scanning module is dependent on its lens, the object distance between the document sheet and lens, and the image distance between the lens and optical sensor. If errors of the object and the image distances are generated during the installation of the scanning module, the resolution of the optical scanning module will be affected.

As user demand improved image quality, achieving fewer amplification errors within the optical scanning module becomes an important issue. Most lenses and reflective mirror of the optical scanning module have some production errors, and further positioning errors during installation of components often occur.

In the conventional scanning device, due to the image amplification of the lens is fixed such that the image amplification cannot be adjusted. The total optical length would be shrunk while the chassis moved forward; on the contrary, when the chassis moved toward back, the total optical length would be increased, wherein the chassis with lens, mirror, and CCD board. Thus, the image amplification is different between two moving type of chassis, such that the image would not be focused on the CCD board to generate the loss focus length issue.

### SUMMARY OF THE INVENTION

It is an object of the present invention, the photosensor and lens moved out of the chassis, and placed on the housing of the scanning device to reduce the volume of the chassis within the scanning device.

It is another object of the present invention, which the modified imaged data can be obtained by adjusting the image amplification of the lens.

According to abovementioned objects, the present invention provides a device adjust the image amplification of lens. The device comprises a lens and a photosensor both placed on the housing of the scanning device. When the chassis moved front and rear, the mirror, the lens, and the photosensor will follow the shift position of the chassis to adjust the angle, such that the image can be focused on the photosensor.

Furthermore, the present invention provides a method to adjust the image amplification of the lens in the scanning device. Due to the length of the total track is the length of the A4 sheet, the first optical distance between the first mirror and the lens is fixed, and the second optical distance between the first mirror and the second mirror within the chassis is variable and the length of the second optical distance exhibits linear variation. Thus, the image size can be modified as same as the original document sheet size by adding the linear ratio into the scanning image.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A shows a top view of the structure of the scanning device in accordance with the device disclosed herein;

FIG. 1B shows a schematic of the optical path corresponding to the length of the total track by moving the chassis during scanning process in accordance with the device disclosed herein;

FIG. 2 shows a schematic of the scanning image size as same as the original document sheet after the modification in accordance with a method disclosed herein; and

FIG. 3 shows a schematic of the modification method by adding linear ratio to the scanning image in accordance with a method disclosed herein.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

According to conventional scanning device, the image amplification of lens is fixed, such that the image amplification cannot be adjusted to obtain the accurate image after scanning document sheet. Thus, the present invention provides a device and a method to solve the problem with the conventional scanning device, such that the scanning image can be focused on the photosensor, and the modified image data can be obtained.

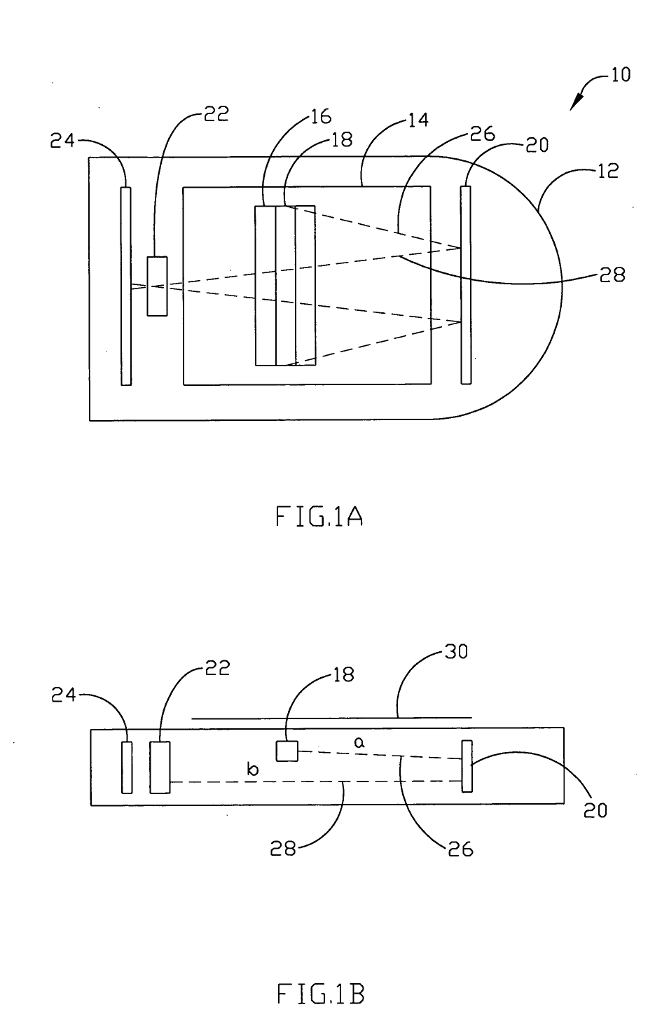

Referring to FIG. 1A, which shows the top view of the scanning device 10. The reference number 12 is housing of the scanning device; the reference number 14 is scan window; the reference number 18 is first mirror within the chassis 16, which used to reflect the illuminating light from the document sheet after scanning to the second mirror 20. In the present invention, the lens 22 and the photosensor 24 such as CCD (charge-coupled device) board are moved out of the chassis 18 to place on the housing 12. Thus, the volume of chassis 18 can be diminished to reduce the thickness of the scanning device 10. In addition, the reference number 26 is first optical path that has a distance between the first mirror 18 and the second mirror 20 after scanning document sheet, and reference number 28 is second optical path that has a distance between the second mirror 20 and the lens 22. Then, the image will reflect to the lens 22 and focus the image on the CCD board 24.

Referring to FIG. 1B, which is projection schematic of the FIG. 1A. The reference number 30 is document sheet; the symbol a represents the first optical 26, which is between the first mirror 18 to the second mirror 20, wherein the distance of the first optical path 26 is variable and the distance exhibits the linear variation, and the symbol b represents the second optical path, which is 28 between the first mirror 18 to the lens 22. When the chassis 16 moved toward back, the optical path of the TT (total track) will be increased, or the chassis 16 moved forward, the optical path of the TT would be shrunk. The image amplification of the lens 22 is different during the chassis 16 moved front and rear to cause the scanning image size is different from the original document sheet, wherein the optical path of the TT is the distance of the first optical path 26 plus the second optical path 28.

Thus, the present invention provides a device to solve the problem of the scanning image size is different from the original document sheet. In the preferred embodiment, the lens 22 and CCD board 24 placed on the housing 12, such that the length between the lens 22 and first mirror 18 is fixed. When the chassis 16 moved front and rear, the first mirror 18, lens 22, and CCD board 24 will follow the shift position of the chassis 16 to adjust the angle, such that the image can be focused on the CCD board 24 completely.

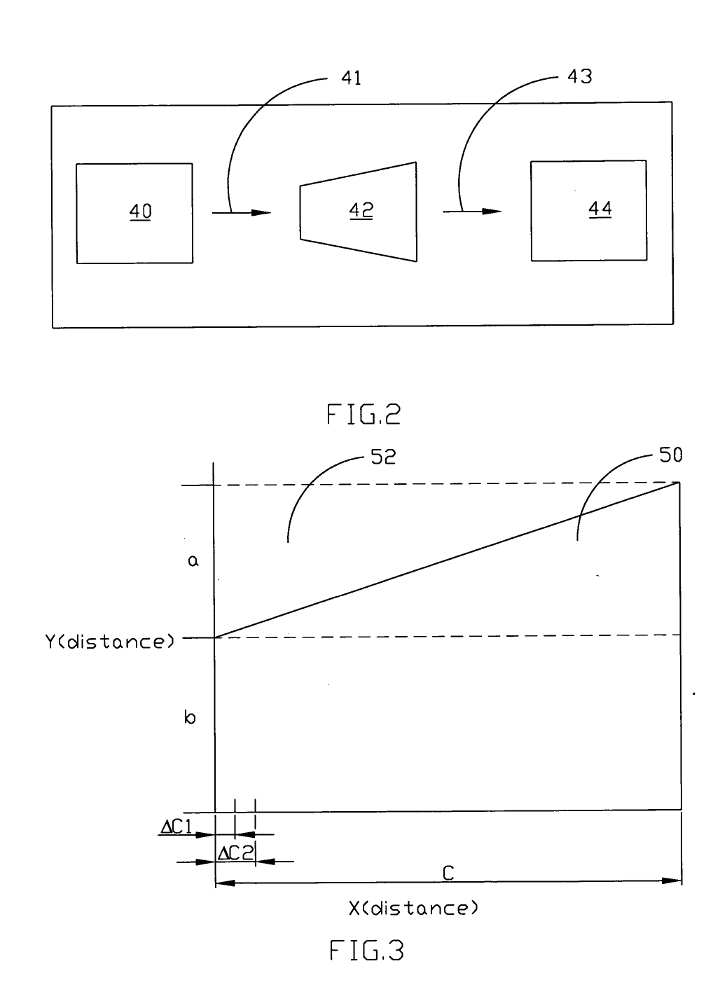

Referring to FIG. 2, which represents the document sheet 40 is scanned to form an imaging 42 with the size that is different from the original document sheet 40, and modified the imaging 42 to form a modified imaging 44 with the same size as the original document sheet 40. During the scanning document sheet process 41, the document sheet size should be smaller than the focal depth of lens 22 to form the imaging, such that the imaging would not be loss the focal length, when the imaging project to the CCD board 24. Then, in the preferred embodiment of the present invention, the scanning image 42 can be modified by a modification method 43 to adjust the image amplification of lens, herein, the change of the image amplification of lens is based on the total length of the optical path. Therefore, the imaging can focused completely on the CCD board 24 and would not be changed by different length of TT. Thus, the image size would be the same as the original document sheet after the modification process.

Furthermore, the present invention provides a method to adjust the image that is focused on the CCD board. Referring to FIG. 3, which shows the x-y coordinate schematic, the x-coordinate denotes the distance, which represents the width of the A4 document sheet size, and the y-coordinate denotes the distance, which denotes the length of the A4 document size. The area of the trapezoid-shaped 50 is a scanning imaging after scanning process. Owing to the image amplification of the lens 22, the scanning imaging size is different from the original document sheet. Furthermore, comparing the scanning imaging and the original document sheet, the scanning imaging lacks of the triangular region 52, which is dotted line region. Therefore, the present invention utilized the distance of the first optical path is linear variation, thus, the trapezoid-shaped 50 is added a linear ratio to modify the scanning imaging to form the modified imaging that has the same imaging size as well as the original document sheet.

Although specific embodiments have been illustrated and described, it will be obvious to those skilled in the art that various modifications may be made without departing from what is intended to be limited solely by the appended claims.

1. A method for correcting image data, said method comprising:
scanning a document sheet to obtain an image data, a first optical path, and a second optical path, wherein the distance of said first optical path is variable, and a distance of said second optical path is fixed; and
modifying said image data by using a linear ratio.

2. The method according to claim 1, wherein said scanning said document sheet further comprising obtains a optical path of total track.

3. The method according to claim 2, wherein the length of said optical path of said total track is changed follows a shift position of a chassis.

4. The method according to claim 1, wherein said first optical path is a distance between a first mirror and a second mirror.

5. The method according to claim 1, wherein said first mirror within said chassis.

6. The method according to claim 1, wherein said second optical path is a distance between said first mirror and a lens.

7. The method according to claim 1, wherein said lens on said housing within said scanning device.

8. A device for adjusting an image data, said device comprising:
a housing having a lens, a charge coupled device, and a second mirror thereon, wherein a distance of the second optical pathis between said lens and said first mirror; and
a chassis having a first mirror, wherein a distance of a first optical path is between said first mirror and said second mirror.

9. The device according to claim 8, wherein said distance of said first optical path is a fixed.

10. The device according to claim 8, wherein said distance of said second optical path is a variable.

11. The device according to claim 8, wherein said distance of said first optical path is change followed with a shift position of said chassis.
